(19) United States
(12) Patent Application Publication
(10) Pub. No.: US 2008/0273274 A1
(43) Pub. Date: Nov. 6, 2008

(54) Magnetic detection element and manufacturing method thereof

(76) Inventors: Shuichi Kojima, Kanagawa (JP); Goichi Kojima, Akita-ken (JP); Misuzu Kanai, Kanagawa (JP); Ysaunari Tajima, Kanagawa (JP); Satoru Okamoto, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/012,864

(22) Filed: Feb. 5, 2008

(30) Foreign Application Priority Data
May 2, 2007 (JP) 2007-025752

(51) Int. Cl. G11B 5/33

(52) U.S. Cl. 360/315

(57) ABSTRACT

Embodiments of the present invention help to suppress etching damage to a non-magnetic intermediate layer in manufacturing steps of a reproducing head. In one embodiment, a reproducing head has two junction insulating films between side ends of magnetoresistive sensor and hard bias films at both left and right of a track width direction of the magnetoresistive sensor. The reproducing head has first junction insulating films in addition to second junction insulating films. The first junction insulating film suppresses etching damage to the non-magnetic intermediate layer in the manufacturing steps of the reproducing head

### CROSS-REFERENCE TO RELATED APPLICATION

The instant nonprovisional patent application claims priority to Japanese Patent Application No. 2007-025752 filed Feb. 5, 2007 and which is incorporated by reference in its entirety herein for all purposes.

### BACKGROUND OF THE INVENTION

A hard disk drive (HDD) is equipped with a magnetic recording medium and a magnetic head, and the magnetic head reads and writes data on the magnetic recording medium. The magnetic head in the HDD comprises a recording head for recording information on the magnetic recording medium (magnetic disk) as magnetic signals and a reproducing head for reading out signals recorded on the magnetic recording medium as magnetic signals. The reproducing head includes a magnetoresistive effect stacked body consisted of a plurality of magnetic thin films and non-magnetic thin films and is called a magnetoresistive effect head because it reads signals by utilizing magnetoresistive effect.

There have been several kinds of sticking structures for the magnetoresistive effect head, and the heads are classified into categories such as an AMR head, a GMR head, a CPP-GMR head, and a TMR head in accordance with the principle of the magnetic resistance used therein. They use a magnetoresistive effect (AMR), a giant magnetoresistive effect (GMR), a current perpendicular plane GMR effect (CPP-GMR effect), a tunnel magnetoresistive effect (TMR), respectively, and retrieve input magnetic fields entering the reproducing head from the magnetic recording medium as voltage changes.

Currently, development in high sensitivity has caused requirement for a reproducing scheme with higher sensitivity. In the range of 70 to 150 (Gb/in.²), the TMR which has a very high MR ratio is advantageous in view of improvement of sensitivity. For ultra high recording density exceeding 150 (Gb/in.²), the CPP-GMR or the like will be main. The TMR is disclosed in Japanese Patent Application No. 3-154217 (“Patent Document 1”), for example. The CPP-GMR is disclosed in Japanese Patent Application No. 11-509956 (“Patent Document 2”), for example. Being different from the current in plane GMR (CIP-GMR) in which sense current flows parallel to film planes of the magnetoresistive effect stacked body, the TMR and the CPP-GMR are schemes in which the sense current flows perpendicular to the film planes, i.e., in the direction of stacking the film planes. In the present specification, the scheme like this is referred to as a CPP scheme; and the reproducing head like this, a CPP reproducing head.

FIG. 12(a) is a cross-sectional view schematically showing a configuration of the CPP reproducing head 71. FIG. 12(b) is an enlarged view of the vicinity of the right end of the magnetoresistive sensor 712 of FIG. 12(a). The magnetoresistive sensor 712 is provided between a lower shield 711 and an upper shield 713. The lower shield 711 and the upper shield 713 function as magnetic shields and a lower electrode and an upper electrode respectively as well for supplying the magnetoresistive sensor 712 with sense current. Under the upper shield 713, an upper shield underlayer film 714 made of a conductor is provided.

The magnetoresistive sensor 712 includes a sensor underlayer 271, an antiferromagnetic film 272, a fixed layer 273, a non-magnetic intermediate layer 274, a free layer 275, a sensor protective film 276, and a sensor cap film 277 sequentially stacked from the lower layer side. The fixed layer 273 of FIG. 12(a) is a stacked fixed layer. Exchange interaction with the antiferromagnetic film 272 works on the fixed layer 273 so that the magnetization direction is fixed. If the reproducing head 71 is a TMR head, the non-magnetic intermediate layer 274 is formed of an insulator such as magnesium oxide (MgO). If a CPP-GMR is used, the non-magnetic intermediate layer 274 is formed of a non-magnetic conductor such as Cu. The track width of the free layer 275 is denoted by Twf.

If the relative magnetization direction of the free layer 275 to the magnetization direction of the fixed layer 273 changes due to the magnetic field from the magnetic disk, the resistance (current value) of the magnetoresistive sensor 712 changes. Thereby, the reproducing head 71 can detect an external magnetic field. On the right and left of the magnetoresistive sensor 712, hard bias films 715 are provided. The bias fields from the hard bias films 715 act on the free layer 275 to have a single magnetic domain. The hard bias film 715 is formed on the hard bias underlayer film 716. As a lower layer of the hard bias underlayer film 716, a junction insulating film 717 is formed. The junction insulating film 717 is provided between the hard bias underlayer film 716 and a lower shield film 711 and the magnetoresistive sensor 712 and works for the sense current not to flow outside of the magnetoresistive sensor 712.

Next, manufacturing steps of the CPP reproducing head 71 will be described referring to FIG. 13. First, a multilayer film constituting the magnetoresistive sensor 712 is deposited and formed by sputtering (S31). Then, a resist track width is formed by resist coating and patterning (S32) and a track width of the multilayer film magnetoresistive sensor 712 is formed by etching using ion milling (S33). Then, after a junction end (the side end of the magnetic sensor) oxidation is carried out as necessary (S34), the insulating film 717 is formed (S35). Furthermore, the hard bias underlayer film 716 and the hard bias film 715 are formed (S36). Then, the resist is lifted off (S37) and the upper shield film 713 is formed (S38).

In the above-described structure and manufacturing steps of the conventional CPP reproducing head, the junction insulating film 717 is formed after all of the layers of magnetoresistive sensor 712 have been etched (S33). It has now been revealed that in this etching step (S33), the side ends of the magnetoresistive sensor 712 are damaged so that characteristics and reliability of the magnetoresistive sensor 712 are impaired. Especially, if the non-magnetic intermediate layer 274 is formed of an insulator, shunt current in the milling damaged part likely causes dielectric breakdown. Accordingly, it is required to suppress the damage to the side ends of the magnetoresistive sensor 712 in the etching step for the magnetoresistive sensor 712.

### BRIEF SUMMARY OF THE INVENTION

Embodiments of the present invention help to suppress etching damage to a non-magnetic intermediate layer in manufacturing steps of a reproducing head. In the particular embodiment of FIGS. 2(a) and 2(b), a reproducing head 11 has two junction insulating films 16 and 17 between side ends of magnetoresistive sensor 112 and hard bias films 115 at both left and right of a track width direction of the magnetoresistive sensor 112. The reproducing head 11 has first junction insulating films 16 in addition to second junction insulating films 17. The first junction insulating film 16 suppresses etching damage to the non-magnetic intermediate layer 214 in the manufacturing steps of the reproducing head 11.

### BRIEF DESCRIPTION OF THE DRAWINGS

FIG. 1 is a cross-sectional view schematically showing the structure of the magnetic head according to one embodiment.

FIGS. 2(a) and 2(b) are cross-sectional views schematically showing the structure of the reproducing head according to one embodiment.

FIG. 3 is a flowchart showing the manufacturing steps of the reproducing head according to the present embodiment.

FIGS. 4A(I)-4A(III) are illustrative drawings showing the manufacturing steps of the reproducing head according to one embodiment.

FIGS. 4B(IV)-4B(VI) are illustrative drawings showing the manufacturing steps of the reproducing head according to one embodiment.

FIGS. 5(a) and 5(b) are cross-sectional views schematically showing the configuration of another aspect of the reproducing head according to one embodiment.

FIGS. 6(a) and 6(b) show appearances of bias fields of another aspect of the reproducing head according to one embodiment.

FIG. 7 is a flowchart showing the manufacturing steps of another aspect of the reproducing head according to one embodiment.

FIGS. 8A(I)-8A(III) are illustrative drawings showing the manufacturing steps of another aspect of the reproducing head according to one embodiment.

FIGS. 8B(IV)-8B(VI) are illustrative drawings showing the manufacturing steps of another aspect of the reproducing head according to one embodiment.

FIGS. 8C(VII)-8C(IX) are illustrative drawings showing the manufacturing steps of another aspect of the reproducing head according to one embodiment.

FIG. 9 is a graph showing the experiment result of the relationship between the milling depth and the defective rate for shunt with respect to the head structure according to embodiments of the present invention and the conventional head structure.

FIG. 10 is a graph showing the experiment result of the relationship between the milling depth and the hard bias field with respect to the head structure according to embodiments of the present invention and the conventional head structure.

FIG. 11 is a graph showing the experiment result of the relationship between the residual magnetization in the hard bias film and the bias field with respect to the head structure according to embodiments of the present invention and the conventional head structure.

FIGS. 12(a) and 12(b) are cross-sectional views schematically showing the configuration of the conventional CPP reproducing head.

FIG. 13 is a flowchart showing the manufacturing process of the conventional CPP reproducing head.

### DETAILED DESCRIPTION OF THE INVENTION

Embodiments of the present invention relate to a magnetic detection element and a manufacturing method thereof, more particularly, to a magnetic detection element in which sense current flows in a stacking direction of a magnetoresistive sensor multilayer film and a manufacturing method thereof.

An aspect of embodiments of the present invention is a magnetic detection element including a magnetoresistive sensor multilayer film having a fixed layer whose magnetization direction is fixed, a free layer whose magnetization direction is changed in accordance with an external magnetic field, and a non-magnetic intermediate layer between the fixed layer and the free layer; current flowing in a perpendicular direction to a plane of the magnetoresistive sensor multilayer film. This magnetic detection element comprises an upper electrode and a lower electrode formed so as to sandwich the magnetoresistive sensor multilayer film in a top-bottom direction, a first insulating film formed so as to cover a side end of the non-magnetic intermediate layer, and a second insulating film formed on an opposite side of the first insulating film from the magnetoresistive sensor multilayer film so that detection current flows through the magnetoresistive sensor multilayer film between the upper electrode and the lower electrode. The first insulating film reduces the damages by etching to the non-magnetic intermediate layer.

If the magnetic detection element further comprises a magnetic domain control film formed at a side of a side end of the magnetoresistive sensor multilayer film for stabilizing a magnetic state of the free layer, the second insulating film is preferably formed between the magnetic domain control film and the upper electrode. Decreasing the distance between the magnetic domain control film and the free layer and increasing the distance between the magnetic domain control film and the upper electrode reduces leakage of magnetic flux.

The fixed layer, the non-magnetic intermediate layer, and the free layer are sequentially stacked in order from a lower film side, a top surface width of the free layer and a top surface width of the non-magnetic intermediate layer are smaller than a top surface width of the fixed layer, and the first insulating film is formed upper above the top surface of the fixed layer. This protects the non-magnetic intermediate layer in a forming step of the fixed layer, which is a lower layer of the non-magnetic intermediate layer.

The level position of the top surface of the magnetic domain control film at an end of the magnetoresistive sensor film side may be between the top surface position of the free layer and a position 5 nm above the top surface position of the free layer. This improves the bias effect of the magnetic domain control film.

The magnetic detection element may comprise a magnetic domain control film underlayer film which is an adjacent lower layer to the magnetic domain control film formed of Cr or a Cr alloy and an amorphous underlayer which is an adjacent lower layer to the magnetic domain control film underlayer film. This allows formation of a magnetic domain control film having superior characteristics to the predetermined level.

Another aspect of embodiments of the present invention is a method for manufacturing a magnetic detection element including a magnetoresistive sensor multilayer film having a fixed layer whose magnetization direction is fixed, a free layer whose magnetization direction is changed in accordance with an external magnetic field, and a non-magnetic intermediate layer between the fixed layer and the free layer; current flowing in a perpendicular direction to a plane of the magnetoresistive sensor multilayer film.

This manufacturing method deposits the fixed layer, the non-magnetic intermediate layer, and the free layer, etches a plurality of layers including the deposited non-magnetic intermediate layer and forms respective track widths thereof, forms a first junction insulating film so as to cover a side end of the etched non-magnetic intermediate layer, etches lower layers below the non-magnetic intermediate layer and forms a track width after forming the first junction insulating film, and forms a second junction insulating film on an opposite side of the first junction insulating film from the magnetoresistive sensor film after etching the lower layer. Forming the first insulating film reduces the damage caused by etching the non-magnetic intermediate layer.

In one method, the fixed layer, the non-magnetic intermediate layer, and the free layer are formed in order from a lower film side, the free layer and the non-magnetic intermediate layer are etched and respective track widths are formed, the first junction insulating film is formed so as to cover side ends of the patterned free layer and the non-magnetic intermediate layer, the fixed layer is etched and track width thereof is formed after the forming the first junction insulating film, and the second junction insulating film is formed on an opposite side of the first junction insulating film from the magnetoresistive sensor film after the forming the track width of the fixed layer.

The method may form a hard bias film made of a hard magnetic film in order to stabilize a magnetization status of the free layer on an opposite side of the first junction insulating film from the magnetoresistive sensor film after the forming the track widths of the lower layers, and the second junction insulating film is formed after the forming the hard bias film. Thereby, the distance between the magnetic domain control film and the free layer is decreased and the distance between the magnetic domain control film and the upper electrode is decreased so that leakage of magnetic flux can be reduced.

Or, a magnetic domain control film made of a hard magnetic film in order to stabilize magnetization status of the free layer may further be formed on an opposite side of the first junction insulating film from the magnetoresistive sensor film after the forming the second junction insulating film.

In the magnetoresistive sensor detection element having a magnetoresistive sensor multilayer film in which sense current flows in the stacking direction, embodiments of the present invention suppress damage at the side ends of the magnetoresistive sensor in the manufacturing steps.

Hereinafter, particular embodiments of the present invention are described referring to the drawings. Throughout the drawings, the like components are denoted by like reference numerals, and their repetitive description is omitted if not necessary for the sake of clearness in the explanation. In the embodiments described hereinbelow, the present invention is applied to a reproducing head for a hard disk drive (HDD) as an example of a magnetic detection element. The reproducing head according to one embodiment is a current perpendicular plane (CPP) head in which sense current flows in the stacking direction of the magnetoresistive sensor multilayer film (perpendicular to the plane). Particularly, the embodiments have a feature in junction insulating films on the side ends of the magnetoresistive sensor multilayer film.

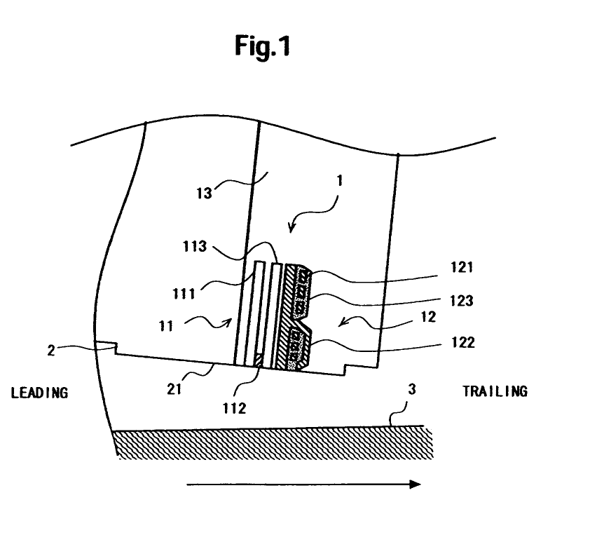

Before describing a feature of the present embodiment, the entire configuration of the magnetic head will be outlined. FIG. 1 is a cross-sectional view schematically showing the structure of the magnetic head 1. The magnetic head 1 reads and writes data from and to the magnetic disk 3. In FIG. 1, the magnetic disk 3 is rotating to the right and the traveling direction of the magnetic head 1 is the left in FIG. 1. The magnetic head 1 is equipped with a reproducing head 11 and a recording head 12 arranged in order from its traveling direction side (leading side). The magnetic head 1 is formed on the trailing side (the other side of the leading side) of a slider 2. The magnetic head 1 and the slider 2 constitute a head slider. The reproducing head 11 contains a lower shield 111, a magnetoresistive sensor 112, and an upper shield 113 in order from the leading side. The recording head 12 contains a thin film coil 121 and recording magnetic poles 122. The thin film coil 121 is enclosed with an insulator.

The recording head 12 is an inductive element for generating magnetic fields between recording magnetic poles 122 from electric current running through the thin film coil 121 and for recording magnetic data onto the magnetic disk 3. The reproducing head 11 is a magnetoresistive element and contains a magnetoresistive sensor 112 having magnetic anisotropy and reads out magnetic data recorded on the magnetic disk 3 by use of resistance which changes in accordance with the magnetic fields from the magnetic disk 3. The reproducing head of the present embodiment is a CPP reproducing head and the lower shield 111 and the upper shield 113 are used as electrodes for supplying the magnetoresistive sensor 112 with detection current.

The magnetic head 1 is formed on an AlTiC substrate constituting the slider 2 by using a thin film forming process. The magnetic head 1 and the slider 2 constitute a head slider. The head slider flies over the magnetic disk 3 and the surface 21 facing the magnetic disk is called an air bearing surface (ABS). The magnetic head 1 is equipped with a protective film 13 made of such as alumina around the recording head 12 and the reproducing head 11, and the entire magnetic head 1 is protected by the protective film 13.

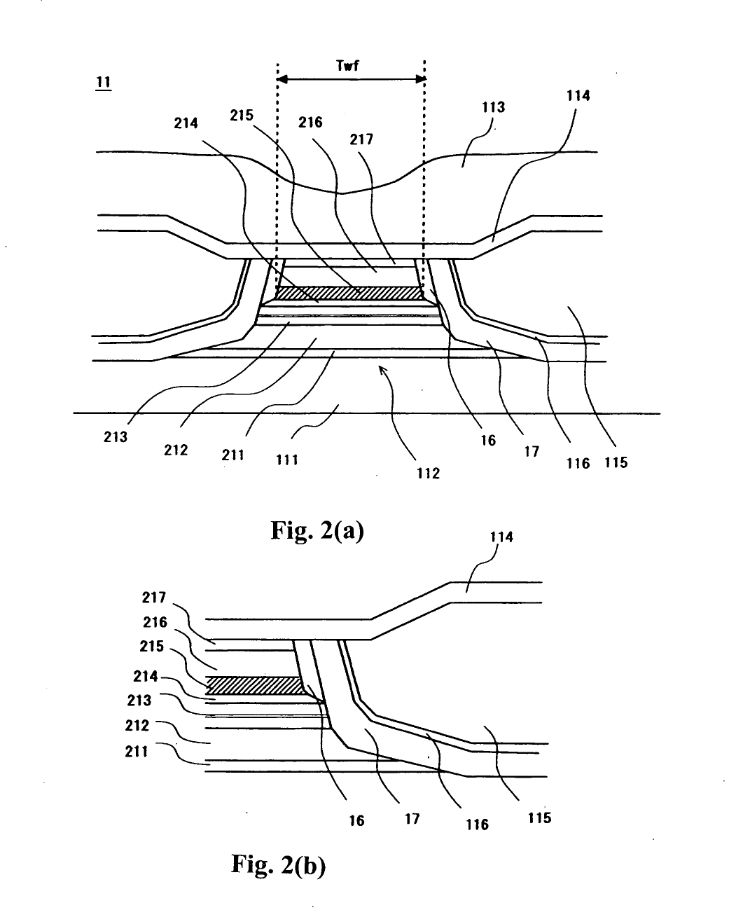

FIG. 2(a) is a cross-sectional view schematically showing a configuration of the reproducing head 11 of the present embodiment by way of example of a magnetoresistive detecting element. FIG. 2(a) schematically shows its cross-sectional structure as viewed from the ABS 21 of the head slider, i.e., the flying surface facing the magnetic disk 3. FIG. 2(b) is an enlarged view of the vicinity of the right end part of the magnetoresistive sensor 112. The bottom of FIG. 2(a) is the leading side and the top is the trailing side. In the present specification, the AlTiC substrate side on which the reproducing head 11 is formed, i.e., the slider 2 side, is defined as the bottom and the opposite trailing side is defined as the top. Each layer of the reproducing head 11 is formed sequentially from the bottom. The reproducing head 11 of the present embodiment is a CPP reproducing head such as a tunneling magnetoresistive (TMR) head or a current-perpendicular-plane-magnetoresistive (CPP-MR) head and sense current flows in the top-bottom direction in FIG. 2(a).

The magnetoresistive sensor 112 is provided between the lower shield 111 and the upper shield 113. The lower shield 111 and the upper shield 113 are formed of conductive magnetic material and function as magnetic shields, and a lower electrode and an upper electrode respectively for supplying sense current to the magnetoresistive sensor 112. The lower shield 111 and the upper shield 113 are made of an alloy containing element such as Ni, Fe, Co, or the like. Under the upper shield 113, an upper shield underlayer film 114 made of a conductor is formed.

The magnetoresistive sensor 112 is a stacked body having a plurality of layers. The magnetoresistive sensor 112 comprises a sensor underlayer 211, an antiferromagnetic film 212, a fixed layer 213, a non-magnetic intermediate layer 214, a free layer 215, a sensor protective film 216, and a sensor cap film 217 stacked sequentially from the lower layer. The respective layers physically contact the adjacent layers.

The sensor underlayer 211 is made of non-magnetic material such as Ta and a NiFeCo alloy, and may be a single layer structure as shown in the drawing or a stacked structure. The antiferromagnetic layer 212 is made of antiferromagnetic material such as PtMn. The fixed layer 213 in FIG. 2(a) is a stacked fixed layer and is constituted by two ferromagnetic films formed of such as a CoFe alloy and a non-magnetic layer therebetween made of such as Ru. The two ferromagnetic films are coupled by exchange interaction and fixed magnetization is stabilized. The magnetizing direction of the lower ferromagnetic film is fixed by the exchange interaction with the antiferromagnetic film 212. The fixed layer 213 may be a single layer structure.

If the reproducing head 11 is a TMR head, the non-magnetic intermediate layer 214 is made of an insulator such as magnesium oxide (MgO) and functions as a tunnel barrier. On the other hand, if the reproducing head 11 utilizes the CPP-GMR, the non-magnetic intermediate layer 214 is formed by using a non-magnetic conductor such as Cu. The free layer 215 is formed of a magnetic metal substance such as a NiFe alloy or a CoFe alloy. The free layer 215 may be a single layer or a stacked structure. The track width of the free layer 215 is denoted by Twf. The sensor protective film 216 and the sensor cap film 217 are made of a non-magnetic conductor such as Ta.

When the relative magnetizing direction of the free layer 215 with respect to the magnetizing direction of the fixed layer 213 changes in accordance with the magnetic field from the magnetic disk 3, the resistance (current value) of the magnetoresistive sensor 112 changes. The reproducing head 11 thereby can detect an external magnetic field. In order to suppress noise, such as Barkhausen noise caused by non-uniform magnetic domains of the free layer 215, hard bias films 115 which are magnetic domain control films are provided at the right and left sides of the magnetoresistive sensor 112. A bias field from the hard bias film 115 controls the magnetic domains of the free layer 215 and acts on the free layer 215 to have a single magnetic domain. The hard bias film 115 is formed in contact with and above the hard bias underlayer film 116.

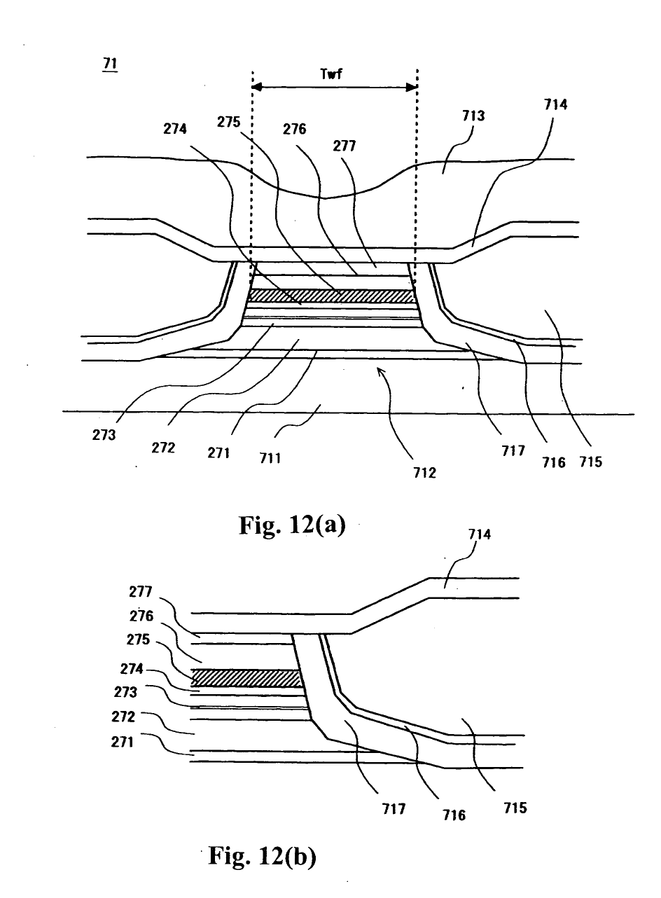

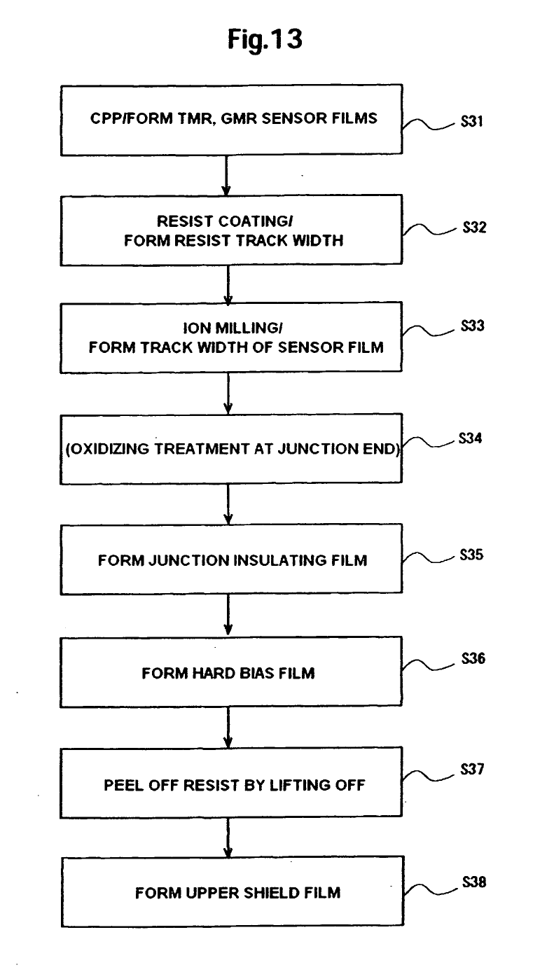

As shown in FIG. 2(b), the reproducing head 11 of the present embodiment has two junction insulating films 16 and 17 between the side ends of the magnetoresistive sensor 112 and the hard bias films 115 on the right and left sides in the track width direction of the magnetoresistive sensor 112. A first junction insulating film 16 and a second junction insulating film 17 may be made of Al₂O₃, for example. Compared to the structure of the conventional reproducing head structure shown in FIG. 12(a), the reproducing head 11 of the present embodiment has the first junction insulating film 16 in addition to the second junction insulating film 17. The first junction insulating film 16 suppresses etching damage of the non-magnetic intermediate layer 214 in the manufacturing steps of the reproducing head 11, which will be further described later.

As shown in FIG. 2(b), the first junction insulating film 16 is provided directly in contact with the side end of the magnetoresistive sensor 112. The first junction insulating film 16 is formed so as to cover the non-magnetic intermediate layer 214 of the magnetoresistive sensor 112 and the upper layers above it. Specifically, the first junction insulating film 16 covers the side ends of the non-magnetic intermediate layer 214, the free layer 215, the sensor protective film 216, and the sensor cap film 217.

The upper width of the fixed layer 213 (the interface width with the non-magnetic intermediate layer 214) is larger than the ones of the respective upper layers above the fixed layer of the magnetoresistive sensor 112 so that a step exists on the side end of the magnetoresistive sensor 112 and a recess (depressed part) exists above the side end of the fixed layer 213. The first junction insulating film 16 is formed on the recess and is present as an upper layer above the fixed layer 213. Therefore, the first junction insulating film 16 does not cover the side ends of the fixed layer 213 and its respective lower layers.

On the opposite side of the first junction insulating film 16 from the magnetoresistive sensor 112, the second junction insulating film 17 is provided. The second junction insulating film 17 is in contact with the side end of the first junction insulating film 16 and the side ends of the fixed layer 213 and the lower layers below fixed layer 213. On the opposite side of the second junction insulating film 17 from the magnetoresistive sensor 112, the hard bias film 115 is provided. The second junction insulating film 17 is provided between the first junction insulating film 16 and the hard bias film 115, between the hard bias film 115 and the fixed layer 213 and the lower layers below the fixed layer 213, and between the lower shield film 111 and the hard bias film 115.

The second junction insulating film 17 insulates the upper shield film 113 and the lower shield film 111 from each other outside of the magnetoresistive sensor 112 and blocks off sense current outside of the magnetoresistive sensor 112. This prevents the sense current from flowing through the hard bias film 115 outside of the magnetoresistive sensor 112 and makes the sense current flow through the non-magnetic intermediate layer 214 in the magnetoresistive sensor 112.

The hard bias film 115 is made of such as a CoCrPt alloy or a CoPt alloy and is conductive. The hard bias underlayer film 116 is a conductor made of such as Cr. In the structure of FIG. 2(b), the hard bias film 115 is in electrically contact with the upper shield 113. Therefore, the second junction insulating film 17 prevents the sense current from flowing between the upper shield film 113 and the lower shield film 111 not through the non-magnetic intermediate layer 214 but through the hard bias film 115, so that required output from the magnetoresistive sensor 112 is achieved.

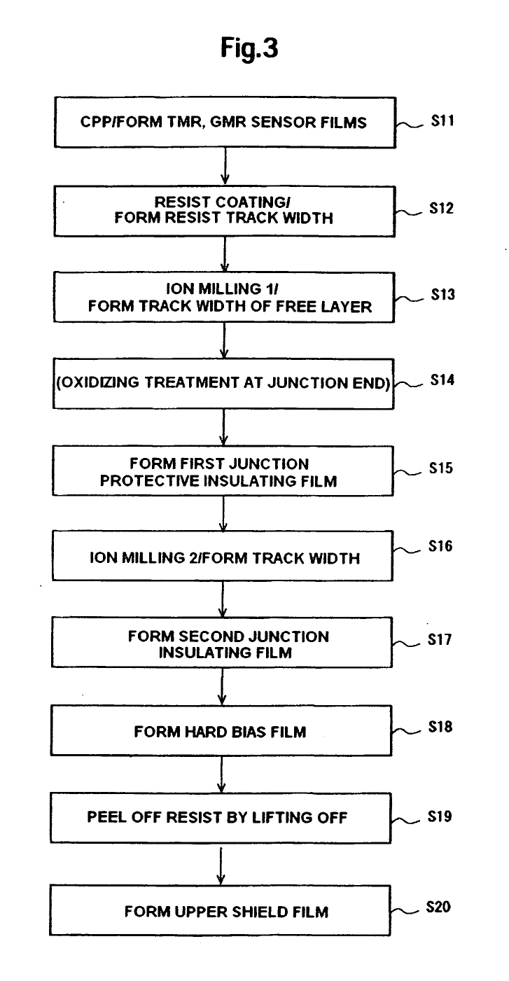

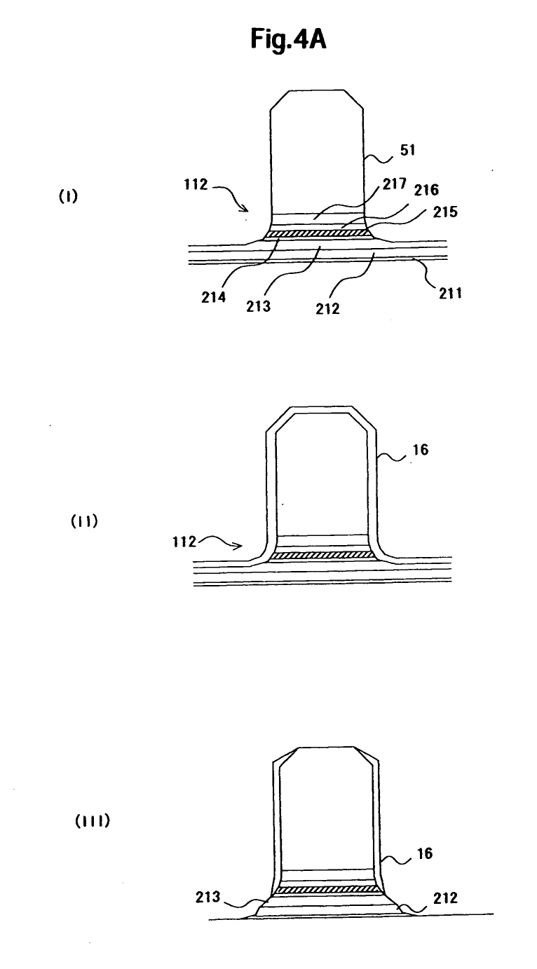

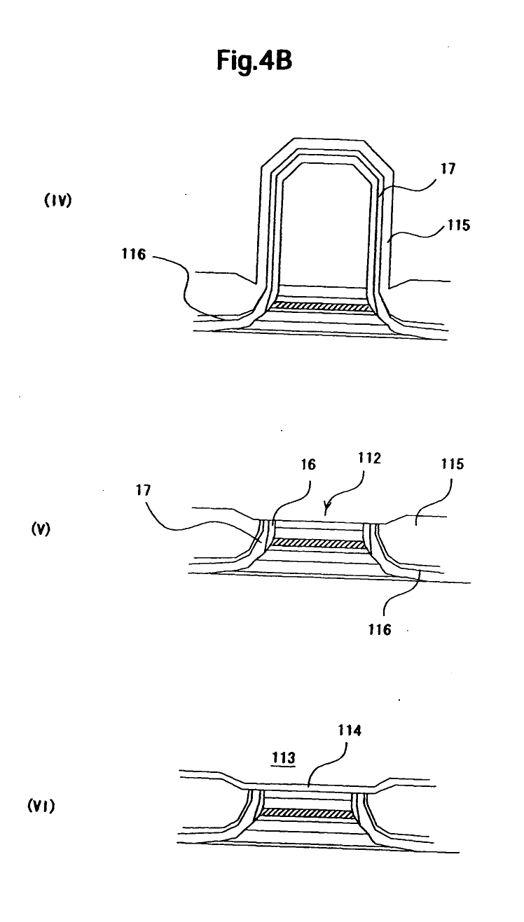

Next, manufacturing steps of the reproducing head structure shown in FIG. 2(a) will be described and the function of the first junction insulating film 16 in the manufacturing steps will be described, referring to a flowchart of FIG. 3 and illustrative drawings of steps in FIGS. 4. First, a multilayer film constituting the magnetoresistive sensor 112 is deposited by sputtering deposition (S11). Then, as shown in FIG. 4A(I), a resist layer 51 is formed by resist coating and patterning (S12), and a track width of the free layer is formed by etching using ion milling (S13). This etching forms track widths of the respective layers from the sensor cap film 217 to the non-magnetic intermediate layer 214. Further, a part of the fixed layer 213 is etched.

Then, after a junction end (the side end of the magnetic sensor) oxidization has been performed (S14) as necessary, the first junction insulating film 16 is deposited (S15) as shown in FIG. 4A(II). Then, as shown in FIG. 4A(III), the track widths of the respective layer of the magnetoresistive sensor 112 lower than the fixed layer 215 are formed by etching using the ion milling (S16). Further, as shown in FIG. 4B(IV), the second junction insulating film 17, the hard bias underlayer film 116, and the hard bias film 115 are formed (S17, S18). Then, as shown in FIG. 4B(V), the resist is lifted off (S19) and as shown in FIG. 4B(VI), the upper shield film 113 is formed (S20).

In the above steps, after the non-magnetic intermediate layer 214 has been etched by ion milling its side ends (and the side ends of the respective upper layers above it) are covered by the first junction insulating film 16. Thereby, in the following ion milling step for the lower layers including the fixed layer 215 (S16), the side ends of the non-magnetic intermediate layer 214 are not exposed so that damage in the ion milling step (S16) is suppressed. This results in preventing the reliability and characteristics of the CPP magnetoresistive sensor from being impaired. Especially, if the non-magnetic intermediate layer 214 is an insulating film, shunt damage in the intermediate insulating film caused by the ion milling damage can be prevented and the reliability is improved.

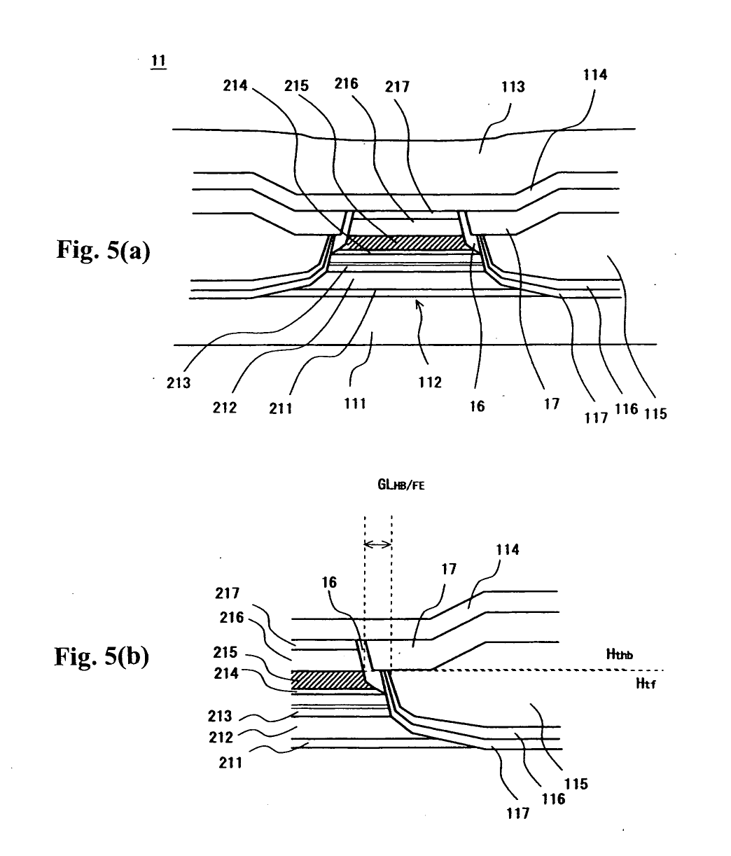

Next, a structure and a manufacturing method of a reproducing head according to another embodiment of the present invention will be described. FIG. 5(a) is a cross-sectional view schematically showing the reproducing head 11 according to another embodiment. FIG. 5(a) schematically shows a cross-sectional structure as viewed from the ABS side of the head slider. FIG. 5(b) is an enlarged view of the vicinity of the right end of the magnetoresistive sensor 112 in FIG. 5(a). The biggest difference between the structure of the reproducing head 11 shown in FIGS. 5(a) and 5(b) and the structure of the reproducing head 11 shown in FIGS. 2(a) and 2(b) is the position of the second junction insulating film 17.

In the structure shown in FIGS. 2(a) and 2(b), the second junction insulating film 17 is provided between the hard bias film 115 and the free layer 215 in the track width direction in addition to the first junction insulating film 16. This increases a distance GLHB/FE between the free layer 215 and the hard bias film 115 in the track width direction. On the contrary, in the structure shown in FIGS. 5(a) and 5(b), the second junction insulating film 17 is formed as an upper layer above the free layer 215 so that the second junction insulating film 17 is not present between the hard bias film 115 and the free layer 215.

Consequently, the side end of the hard bias film 115 at the free layer 215 side can get closer to the side end of the free layer 215 to apply a bias field to the free layer 215 more properly. Because of more efficient application of the magnetic field, the hard bias film 115 can be thinned and the upper shield film 113 can be more flattened in the region overlapping the magnetoresistive sensor 112. Thereby, the shield property of the upper shield film 113 is improved and the reading capability is improved.

With regard to the position of the second junction insulating film 17, followings are additionally important. The structure shown in FIGS. 2(a) and 2(b) has the second junction insulating film 17 between the lower shield film 111 and the hard bias film 115. On the other hand, in the reproducing head 11 shown in FIGS. 5(a) and 5(b), the second junction insulating film 17 is provided between the hard bias film 115 and the upper shield film 113.

Providing the second junction insulating film 17 above the hard bias film 115 allows increasing the distance between the hard bias film 115 and the upper shield film 113. This reduces leakage of magnetic flux from the hard bias film 115 to the upper shield film 113 and provides the free layer 215 with a bias field from the hard bias film 115 properly.

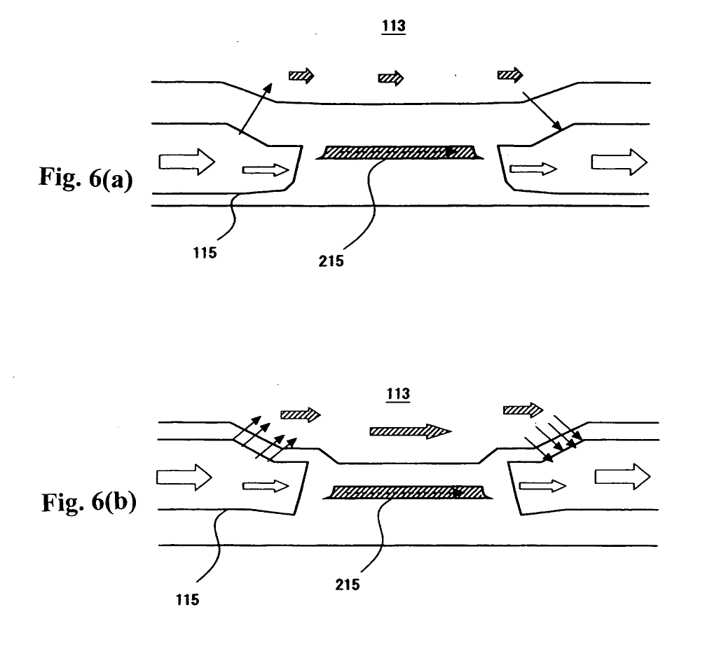

FIG. 6 schematically shows changes in bias field in accordance with the position (level position) of the hard bias film 115 in the stacking direction of the magnetoresistive sensor multilayer film. FIG. 6(a) corresponds to the structure in which the second junction insulating film 17 is formed as an tipper layer above the hard bias film 15 and FIG. 6(b) corresponds to the structure that the second junction insulating film 17 is formed as a lower layer below the hard bias film 115.

As shown in FIG. 6(b), when the second junction insulating film 17 is formed lower than the hard bias film 115, a part of the magnetic flux from the hard bias film 115 flows into the upper shield film 113 so that the bias field to the free layer 215 reduces. This requires increase of the film thickness of the hard bias film 115 and the shape of the upper shield film 113 becomes uneven.

On the contrary, as shown in FIG. 6(a), when the second junction insulating film 17 is formed upper than the hard bias film 115, the level of the hard bias film 115 is lowered so that the leakage of the magnetic flux can be reduced. This allows that the hard bias film 115 is thinned and the upper shield film 113 is flattened so that the reading capability is improved.

The top surface level position of the hard bias film 115 at the end of the free layer side (Hthb in FIG. 5(b)) is preferably substantially the same as the level position of the top of the free layer (free layer top height position) (Htf in FIG. 5(b)) or within not more than 5 nm above the top level position of the free layer. This enables to thin the hard bias film 115 and to provide the free layer 215 with an effective bias field.

As shown in FIG. 5(b), since the second junction insulating film 17 is not present between the hard bias film 115 and the fixed layer 213, the hard bias film 115 is in electrically contact with the fixed layer 213 via the hard bias underlayer film 116 and an amorphous underlayer film 117 of conductive films. Here, the structure shown in FIG. 5(b) includes an amorphous underlayer film 117 in addition to the hard bias underlayer film 116. The hard bias underlayer film 116 controls the crystallized state of the hard bias film 115 and the amorphous underlayer film 117 controls the crystallized state of the hard bias underlayer film 116.

Since the hard bias film 115 requires high retention and high magnetic flux density, it is preferable to be formed of a Co alloy with Co as the principal component, such as CoCrPt. Then, it is preferable to adjust the composition of the Co alloy to adjust such as the saturation magnetic flux density. To generate a uniform and strong bias field with less fluctuation, it is important to control and adjust polycrystal orientation distribution of the Co-alloy magnetic film. Preparing the hard bias underlayer film 116 of Cr or a Cr alloy and controlling and adjusting the orientation distribution thereof result in controlling the polycrystal orientation of the Co alloy magnetic film, which is the hard bias film 115.

The orientation of the hard bias underlayer film 116 made of Cr or a Cr alloy can be controlled and adjusted with the amorphous underlayer film 117 which is the underlayer of the hard bias underlayer film 116. On the layers of polycrystal films having almost face-centered structures in the magnetoresistive sensor multilayer film 112, only specific orientation distribution of Cr and Co can be realized. Selecting the material of the amorphous underlayer film 117 enables to desirably adjust and control the orientation distribution of the Co alloy hard bias film 115.

As the materials of the amorphous underlayer film 117, additive elements are included in a main layer of such as Ni or Co. The elements to be added are such as P, Cr, Zr, Nb, and Hf. One or more of these elements are added to the Ni or Co to form the amorphous structure. It is important that the oxidization condition of the surface of the amorphous underlayer film 117 is adjusted by oxidization treatment to adjust the surface energy. In the structure shown in FIGS. 2(a) and 2(b), in the case that the hard bias underlayer film 116 and the hard bias film 115 are formed on the second junction insulating film 17, the orientation control using the amorphous underlayer film 117 can be applied.

Since the amorphous underlayer film 117 and the hard bias underlayer film 116 are conductors as described above, if they are in electrically contact with the upper shield film 113 and the lower shield film 111, sense current flows therein. In the head structure shown in FIG. 5(b), at the side end of the first junction insulating film 16, the second junction insulating film 17 is present between the amorphous underlayer film 117, the hard bias underlayer film 116 and the upper shield film 113. Thereby, current flowing from the upper shield film 113 to the amorphous underlayer film 117 and the hard bias underlayer film 116 is cut off.

Specifically, at the side end of the first junction insulating film 16, the top ends of the amorphous underlayer film 117 and the hard bias underlayer film 116 are removed and the level positions of their top surfaces coincide with the level position of the end part of the hard bias film 115. The first junction insulating film 16 has a recess formed by removing the top end of the amorphous underlayer film 17 and the hard bias underlayer film 116 and a part of the second junction insulating film 17 is formed so as to fill the recess and is in direct contact with the first junction insulating film 16.

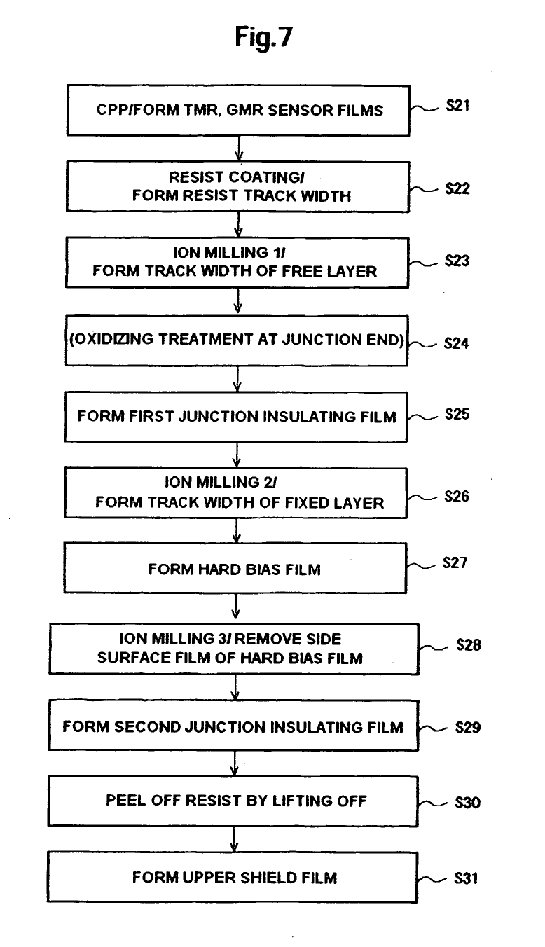

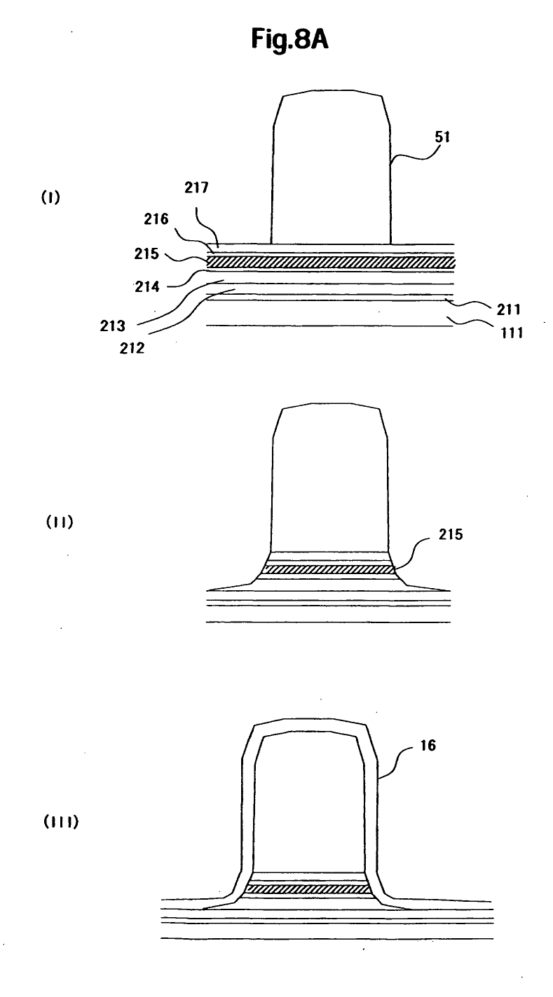

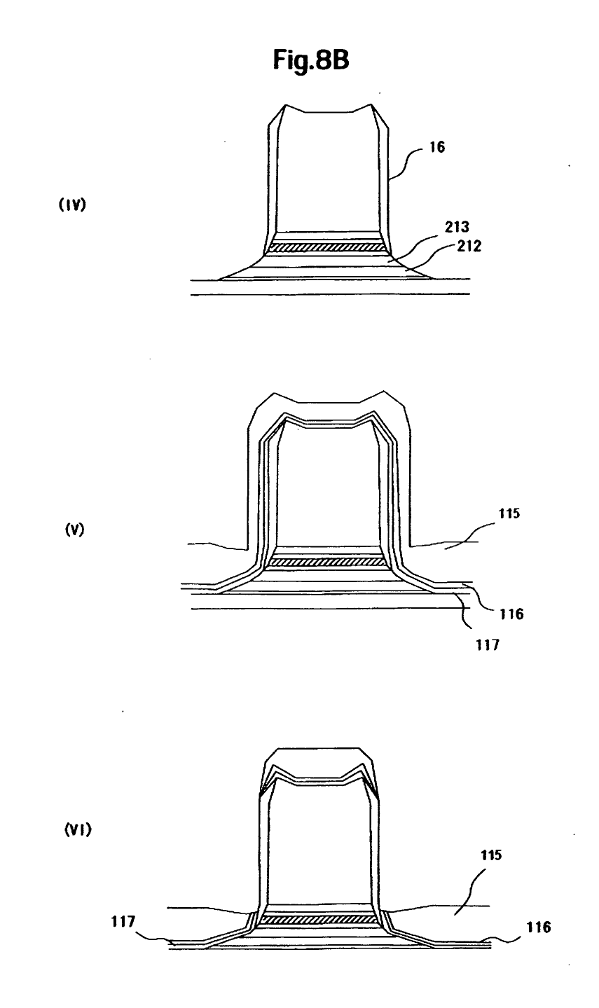

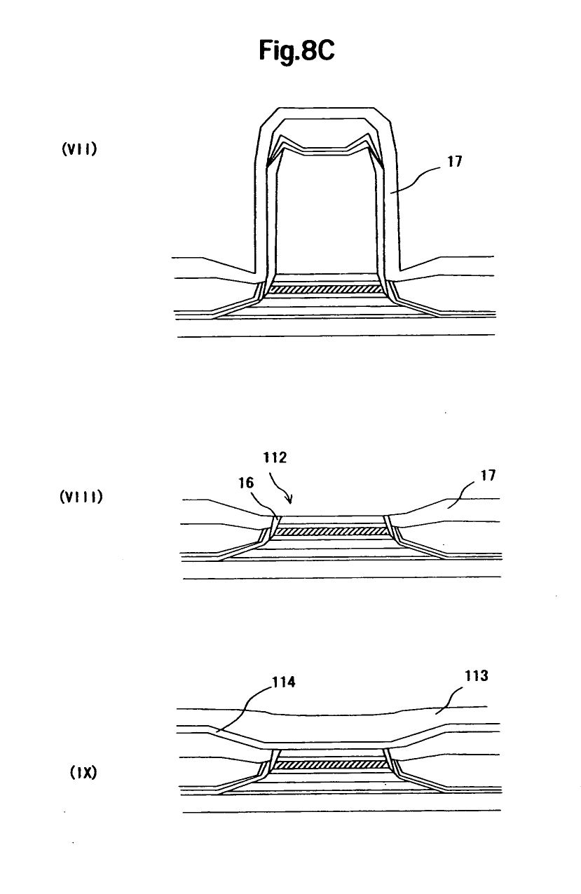

Next, manufacturing steps of the reproducing head 11 having the structure shown in FIG. 5(a) will be described referring to a flowchart of FIG. 7 and step illustrative drawings of FIGS. 8. First, a multilayer film constituting the magnetoresistive sensor 112 is deposited by sputtering deposition (S21). Then, as shown in FIG. 8A(I), a resist layer 51 is formed by resist coating and patterning (S22), and a track width (size in the track width direction) of the free layer is formed by etching using ion milling (S23) as shown in FIG. 8A(II). This etching forms track widths of the respective layers from the sensor cap film 217 to the non-magnetic intermediate layer 214.

Then, after a junction end (the side end of the magnetic sensor) oxidization has been performed (S24) as necessary, the first junction insulating film 16 is deposited (S25) as shown in FIG. 8A(III). Then, as shown in FIG. 8B(IV), the track widths of the respective layer of the magnetoresistive sensor 112 lower than the fixed layer 215 are prepared by etching using the ion milling (S26). Further, as shown in FIG. 8B(V), the amorphous underlayer film 117, the hard bias underlayer film 116, and the hard bias film 115 are deposited by sputtering (S27).

Then, as shown in FIG. 8B(VI), parts of respective layers of the amorphous underlayer film 117, the hard bias underlayer film 116, and the hard bias film 115 are removed by ion milling (S28). This step determines the level position of the end part of the hard bias film 115 at the magnetoresistive sensor side. Moreover, the top ends of the amorphous underlayer film 117 and the hard bias underlayer film 116 on the side end of the first junction insulating film 16 are removed.

Then, the second junction insulating film 17 is deposited (S29) as shown in FIG. 8C(VII), the resist 51 is lifted off (S30) as shown in FIG. 8C(VIII), and the upper shield film 113 is deposited (S31) as shown in FIG. 8(IX). The foregoing steps protect the non-magnetic intermediate layer 214 from being damaged by the ion milling by means of the first junction insulating film 16 and enable to form properly the second junction insulating film 17 above the hard bias film 115.

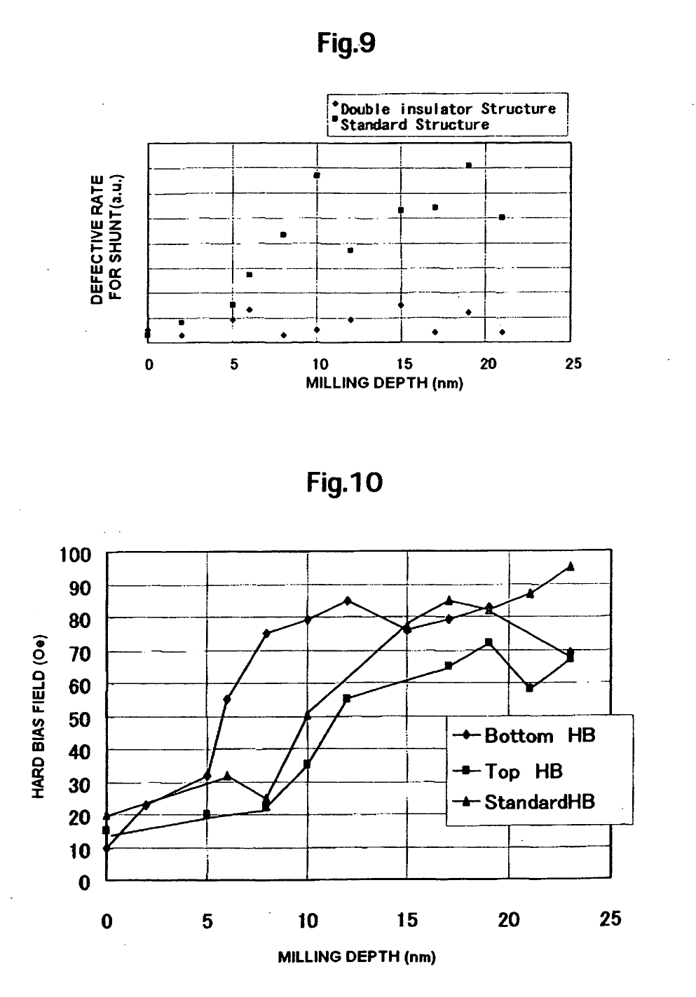

Hereinbelow, experiment results of the examples produced according to the present invention will be described. TMR heads having the structure shown in FIG. 2(a) and TMR heads having a conventional structure were made and their defective rates for shunts were measured. The results are shown in FIG. 9. TMR heads with different milling depths according to embodiments of the present invention and having the conventional structure were respectively made, and measurements of defective rates for shunts with respect to each milling depth are shown in FIG. 9. The milling depth is the one in the step of ion milling a magnetoresistive sensor and is based on the level position of the undersurface of the non-magnetic intermediate layer 214. A 16 nm depth corresponds to the level position of the undersurface of the sensor underlayer 211.

In FIG. 9, diamonds represent the measurements of the TMR heads according to the present invention and squares represent the measurements of the TMR heads with the conventional structure. As understood from this result, the defective rate for shunts in the conventional head structure got worse in the milling depth of not less than 5 nm. On the contrary, in the head structure according to embodiments of the present invention, the defective rate for shunts did not get worse even though the milling depth increased. It is assumed that the same results are obtained in the structure shown in FIG. 5(a).

FIG. 10 shows a relationship between the milling depth and the bias field of the hard bias film 115. Squares represent measurements of TMR heads having the structure shown in FIG. 2(a) (TOP HB); diamonds, of TMR heads having the structure shown in FIG. 5(a) (BOTTOM HB); and triangles, of TMR heads having the conventional structure (STANDARD HB), respectively. The milling depths were under the same conditions as in FIG. 9. As understood from the experiment result of FIG. 10, if the hard bias film 115 was present lower than the second junction insulating film 17 as shown in FIG. 5(a), a stronger bias field and high stability were obtained at a smaller milling depth, compared to the conventional structure or the case that the hard bias film 115 is at an upper position. For example, in the structure that the hard bias film 115 is at a lower position, 80 Oe of bias field was obtained at 10 nm depth; but in the other structures, the depth of not less than 15 nm was required.

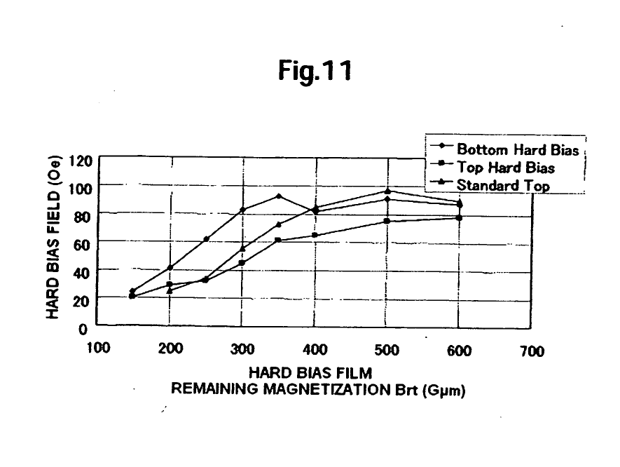

FIG. 11 shows the relationship between the residual magnetization and the bias field of the hard bias film 115. Squares represent measurements of TMR heads having the structure shown in FIG. 2(a) (TOP HB); diamonds, of TMR heads having the structure shown in FIG. 5(a) (BOTTOM HB); and triangles, of TMR heads having the conventional structure (STANDARD HB), respectively. As understood from the experiment result of FIG. 11, if the hard bias film 115 was present lower than the second junction insulating film 17, stronger bias fields were obtained by the hard bias film with smaller residual magnetization, compared to the conventional structure or the case that the hard bias film 115 is at an upper position.

The foregoing experimental results indicate that forming the first and the second junction insulating films suppressed the milling damage in the non-magnetic intermediate layer. They also indicate that forming the hard bias film 115 lower than the second junction insulating film 17 significantly improved the characteristics of the hard bias film 115.

As set forth above, embodiments of the present invention are described by way of example of the preferred embodiments but are not limited to the above embodiments. A person skilled in the art can easily modify, add, and convert each element in the above embodiments within the scope of the present invention. For example, the stacking order of each layer of the magnetoresistive sensor may be inversed. Embodiments of the present invention are particularly useful to a reproducing head of a magnetic disk device, but may be applicable to other magnetic detection elements.

What is claimed is:

1. A magnetic detection element including a magnetoresistive sensor multilayer film having a fixed layer whose magnetization direction is fixed, a free layer whose magnetization direction is changed in accordance with an external magnetic field, and a non-magnetic intermediate layer between the fixed layer and the free layer, current flowing in a perpendicular direction to a plane of the magnetoresistive sensor multilayer film, the magnetic detection element comprising:
an upper electrode and a lower electrode formed so as to sandwich the magnetoresistive sensor multilayer film in a top-bottom direction;
a first insulating film formed so as to cover a side end of the non-magnetic intermediate layer; and
a second insulating film formed on an opposite side of the first insulating film from the magnetoresistive sensor multilayer film so that detection current flows through the magnetoresistive sensor multilayer film between the upper electrode and the lower electrode.

2. The magnetic detection element according to claim 1, further comprising:
a magnetic domain control film formed at a side of a side end of the magnetoresistive sensor multilayer film for stabilizing a magnetic state of the free layer; wherein
the second insulating film is formed between the magnetic domain control film and the upper electrode.

3. The magnetic detection element according to claim 1, wherein
the fixed layer, the non-magnetic intermediate layer, and the free layer are sequentially stacked in order from a lower film side;
a top surface width of the free layer and a top surface width of the non-magnetic intermediate layer are smaller than a top surface width of the fixed layer; and
the first insulating film is formed upper above the top surface of the fixed layer.

4. The magnetic detection element according to claim 2, wherein
the level position of the top surface of the magnetic domain control film at an end of the magnetoresistive sensor film side is between the top surface position of the free layer and a position 5 nm above the top surface position of the free layer.

5. The magnetic detection element according to claim 2, further comprising:
a magnetic domain control film underlayer film which is an adjacent lower layer to the magnetic domain control film formed of Cr or a Cr alloy; and
an amorphous underlayer which is an adjacent lower layer to the magnetic domain control film underlayer film.

6. A method for manufacturing a magnetic detection element including a magnetoresistive sensor multilayer film having a fixed layer whose magnetization direction is fixed, a free layer whose magnetization direction is changed in accordance with an external magnetic field, and a non-magnetic intermediate layer between the fixed layer and the free layer, current flowing in a perpendicular direction to a plane of the magnetoresistive sensor multilayer film, the method comprising:
depositing the fixed layer, the non-magnetic intermediate layer, and the free layer;
etching a plurality of layers including the deposited non-magnetic intermediate layer and forming respective track widths thereof;
forming a first junction insulating film so as to cover a side end of the etched non-magnetic intermediate layer;
etching lower layers below the non-magnetic intermediate layer and forming a track width after forming the first junction insulating film; and
forming a second junction insulating film on an opposite side of the first junction insulating film from the magnetoresistive sensor film after etching the lower layers.

7. The method according to claim 6, wherein
the fixed layer, the non-magnetic intermediate layer, and the free layer are formed in order from a lower film side;
the free layer and the non-magnetic intermediate layer are etched and respective track widths are formed;
the first junction insulating film is formed so as to cover side ends of the patterned free layer and the non-magnetic intermediate layer;
the fixed layer is etched and track width thereof is formed after the forming the first junction insulating film; and
the second junction insulating film is formed on an opposite side of the first junction insulating film from the magnetoresistive sensor film after the forming the track width of the fixed layer.

8. The method according to claim 6, further comprising:
forming a hard bias film made of a hard magnetic film in order to stabilize a magnetization status of the free layer on an opposite side of the first junction insulating film from the magnetoresistive sensor film after the forming the track widths of the lower layers, wherein
the second junction insulating film is formed after the forming the hard bias film.

9. The method according to claim 6, further comprising forming a magnetic domain control film in order to stabilize a magnetization status of the free layer, a hard bias underlayer film which is an adjacent lower layer to the hard bias film and is made of Cr or a Cr alloy, and an amorphous underlayer film which is an adjacent lower layer to the hard bias underlayer film at a side of a side end of the magnetoresistive sensor film.

10. The method according to claim 6, further comprising forming a magnetic domain control film made of a hard magnetic film in order to stabilize a magnetized status of the free layer on an opposite side of the first junction insulating film from the magnetoresistive sensor film after the forming the second junction insulating film.
